(19) United States
(12) Patent Application Publication
(10) Pub. No.: US 2026/0303836 A1
(43) Pub. Date: Oct. 1, 2026

(54) ENTROPY CODING TRANSFORM BLOCKS

(71) Applicant: MEDIATEK INC., Hsinchu City (TW)

(72) Inventor: Shih-Ta HSIANG, Hsinchu City (TW)

(21) Appl. No.: 19/476,943

(22) PCT Filed: Apr. 3, 2024
(86) PCT No.: PCT/CN2024/085889

§ 371 Date: Oct. 20, 2025

Related U.S. Application Data
(60) Provisional application No. 63/498,859, filed on Apr. 28, 2023.

(51) Int. Cl. H04N 19/167; H04N 19/176; H04N 19/18

(52) U.S. Cl. CPC H04N 19/167; H04N 19/176; H04N 19/18

(57) ABSTRACT

A method for entropy encoding or decoding transform coefficients is provided. A video coder encodes or decodes transform coefficients of a transform block according to a scan order based on a position of a last significant transform coefficient in the transform block. The video coder encodes or decodes the position of the last significant transform coefficient. The video coder may determine whether a transform type of the transform block belonging to a two-dimensional non-separable transform type. When the transform type is a two-dimensional non-separable transform type, the position of the last significant transform coefficient is coded as an index in the scan order. When the transform type is not a two-dimensional non-separable transform type, the position of the last significant transform coefficient is coded as Cartesian coordinates in the transform block.

### CROSS REFERENCE TO RELATED PATENT APPLICATION(S)

The present disclosure is part of a non-provisional application that claims the priority benefit of U.S. Provisional Patent Application No. 63/498,859, filed on 28 Apr. 2023. Content of the above-listed application is herein incorporated by reference.

### TECHNICAL FIELD

The present disclosure relates generally to video coding. In particular, the present disclosure relates to methods of entropy coding transform blocks.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

A CTU can be partitioned into one or multiple non-overlapped coding units (CUs) using the quadtree (QT) with nested multi-type-tree (MTT) structure to adapt to various local motion and texture characteristics. There are several split types of a CU, including by QT partitioning and by MTT partitioning. A CU can be further split into smaller CUs by using QT partitioning (SPLIT_QT), or by using one of the four MTT partitioning types: vertical binary partitioning (SPLIT_BT_VER), horizontal binary partitioning (SPLIT_BT_HOR), vertical ternary partitioning (SPLIT_TT_VER), horizontal ternary partitioning (SPLIT_TT_HOR).

A coding tree unit (CTU) is treated as the root of a quaternary tree (or quadtree) and is first partitioned by a quaternary tree structure. Each quaternary tree leaf node (when sufficiently large to allow it) is then further partitioned by a multi-type tree structure.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for entropy encoding or decoding transform coefficients. A video coder encodes or decodes transform coefficients of a transform block according to a scan order based on a position of a last significant transform coefficient in the transform block, such that N transform coefficients of the transform block are coded in the bitstream, N being a number less than or equal to a size (e.g., number of transform coefficients) of the transform block.

The video coder encodes or decodes the position of the last significant transform coefficient. The video coder may determine whether a transform type of the transform block belonging to a two-dimensional non-separable transform type (e.g., LFNST, NSPT). When the transform type is a two-dimensional non-separable transform type, the position of the last significant transform coefficient is indicated by coding an index in the scan order. When the transform type is not a two-dimensional non-separable transform type, the position of the last significant transform coefficient is indicated by coding Cartesian coordinates in the transform block.

In some embodiments, the transform type of the transform block is signaled before the position of the last significant transform coefficient. In some embodiments, the position of the last significant transform coefficient is entropy coded by separate context sets for different transform types. In some embodiments, a maximum codeword value for signaling the index of the position of the last significant transform coefficient is determined by a pre-defined maximum number of transform coefficients for the transform block. In some embodiments, the index of the position of the last significant transform coefficient is signaled as a prefix syntax element and a suffix syntax element (e.g., as syntax elements last_sig-coeff_idx_prefix and last_sig-coeff_idx_suffix.)

### BRIEF DESCRIPTION OF THE DRAWINGS

The accompanying drawings are included to provide a further understanding of the present disclosure, and are incorporated in and constitute a part of the present disclosure.

The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates a diagonal scan order for a 4×4 transform block in a forward scan direction.

FIG. 2 illustrates a scan order for an 8×8 transform block.

FIG. 3 illustrates a transform block with significant and insignificant transform coefficients.

FIG. 4 illustrates an example video encoder that entropy encodes transform coefficients.

FIG. 5 illustrates portions of the video encoder that signals a position of the last significant transform coefficient.

FIG. 6 conceptually illustrates a process for entropy coding transform coefficients.

FIG. 7 illustrates an example video decoder that entropy decodes transform coefficients.

FIG. 8 illustrates portions of the video decoder that receives a position of the last significant transform coefficient.

FIG. 9 conceptually illustrates a process that entropy decodes transform coefficients.

FIG. 10 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Entropy Coding Transform Block

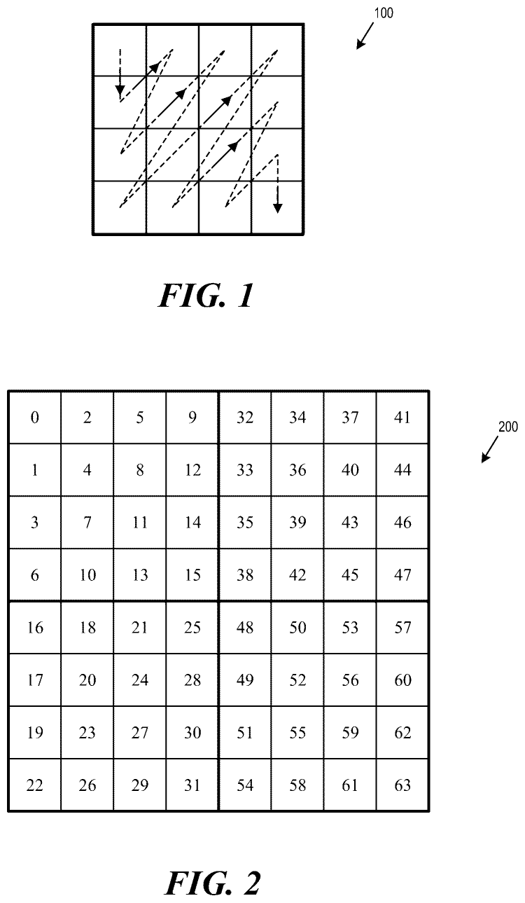

A transform block may be further divided into one or more non-overlapped subblocks. Transform coefficients in each subblock may be coded according to a diagonal scan order in a backward scan direction. Subblocks in a transform block are coded according to a diagonal scan order in a backward scan direction. FIG. 1 illustrates a diagonal scan order for a 4×4 transform block 100 in a forward scan direction.

In some embodiments, the information on the position of the last significant coefficient in scanning order within a transform block is signaled by entropy coding the Cartesian coordinates of the last significant coefficient (LastSignificantCoeffX, LastSignificantCoeffY), wherein LastSignificantCoeffX and LastSignificantCoeffY indicate the column position of the last significant coefficient and the row position of the last significant coefficient within a transform block, respectively. The values of LastSignificantCoeffX and LastSignificantCoeffY are entropy coded by separate sets of syntax elements.

For some embodiments, the transform coefficients in transform block can be indexed or numbered according to their positions in the scan order. For the example 4×4 transform block of FIG. 1, the coefficient at the first or origin position in the scan order can be assigned index ‘0’, while the coefficient at the last position in the scan order can be assigned index ‘15’. In some embodiments, for a larger transform block (e.g., 8×8), the scan order of the transform coefficients may scan through the transform block in a section (e.g., 4×4) by section manner. FIG. 2 illustrates a scan order for an 8×8 transform block 200. The 64 transform coefficient positions are labeled based on the scan order, such that the first position in the scan order is labeled or indexed as ‘0’, and the last position in the scan order is labeled or indexed as ‘63’. As can be seen from the indices assigned to the transform coefficient positions, the scan order scan through the 8×8 transform block in four different 4×4 sub-sections, such that the transform coefficients of one 4×4 sub-sections are scanned diagonally before the transform coefficients of a next 4×4 sub-section.

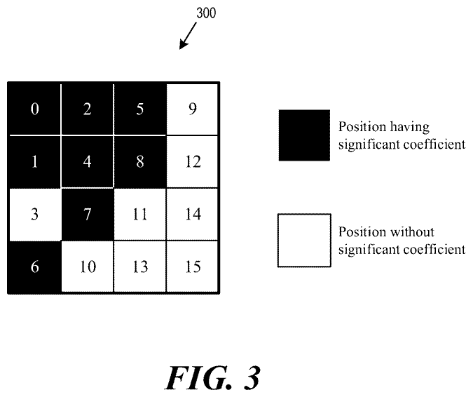

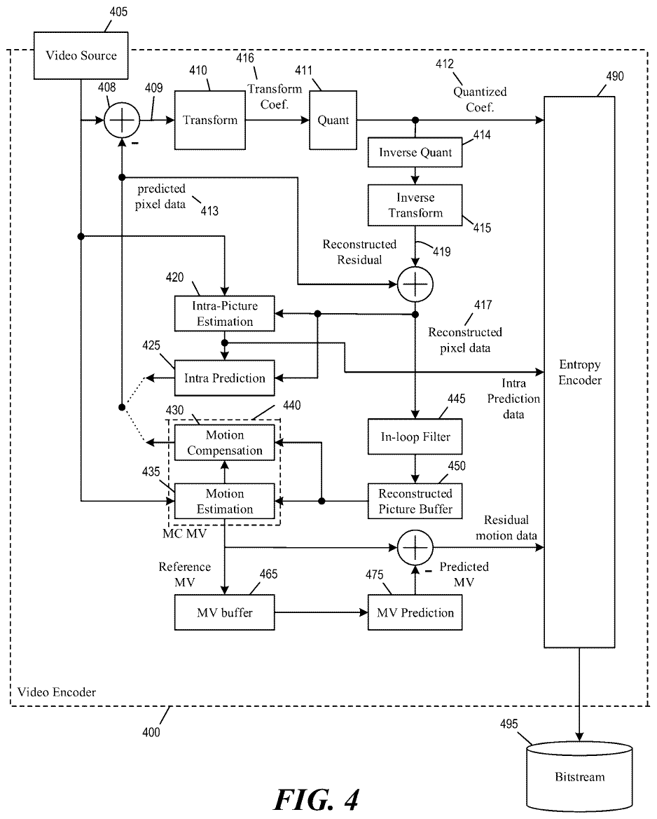

In some embodiments, a video coder may signal information on the position of the last significant coefficient in scanning order within a transform block by entropy coding the index of the last significant coefficient in scanning order within a transform block. Such an index is indicated by a variable LastSignificantCoeffIdx, such that index 0 corresponds to the position at the origin of the current transform block. FIG. 3 illustrates a transform block with significant and insignificant transform coefficients. The figure shows a 4×4 transform block 300 for which the transform coefficients are assigned indices according to their position in the scan order. The darkened positions have significant (e.g., greater than a threshold), or non-zero transform coefficients. The non-darkened positions have insignificant (e.g., less than a threshold), or zero transform coefficients (or less than a threshold). Thus, for this example, position with index ‘8’ is the last significant coefficient in the scan order, so the variable LastSignificantCoeffIdx shall be ‘8’. This allows the video coder to entropy encode or decode only the N transform coefficients of the transform block, N being a number of “significant” coefficients in the transform block, a number that may be less than a size (or maximum number of transform coefficients) of the transform block.

A video coder may signal one or more syntax elements for entropy coding the value of LastSignificantCoeffIdx for a non-zero transform block. The value of LastSignificantCoeffIdx may be binarized using the truncated unary Rice code, the truncated binary code, the k-th order Exp-Golomb (EGk) code or the fixed-length (FL) code, or a combination thereof. In one embodiment, LastSignificantCoeffIdx can be derived by syntax elements last_sig_coeff_idx_prefix and last_sig_coeff_idx_suffix, with semantics as follows:

last_sig_coeff_idx_prefix specifies the prefix of the index of the last significant coefficient in scanning order within a transform block. When last_sig_coeff_idx_prefix is not present, it is inferred to be 0.

last_sig_coeff_idx_suffix specifies the suffix of the index of the last significant coefficient in scanning order within a transform block.

In some embodiments, last_sig_coeff_idx_prefix is coded by a tructaed unary Rice code and last_sig_coeff_idx_suffix is coded by a fixed-length code or a truncated binary code. The index of the last significant coefficient in scanning order within a transform block LastSignificantCoeffIdx is derived as follows:

```
If last_sig_coeff_idx_suffix is not present, the following applies:
  LastSignificantCoeffIdx = last_sig_coeff_idx_prefix
Otherwise (last_sig_coeff_idx_suffix is present), the following applies:
  LastSignificantCoeffIdx =
    ( 1 << ( (last_sig_coeff_idx_prefix >> 1 ) − 1 ) ) *
    ( 2 + (last_sig_coeff_idx_prefix & 1 ) ) +
    last_sig_coeff_idx_suffix
```

In some embodiments, last_sig_coeff_idx_prefix is coded by a tructaed unary Rice code and last_sig_coeff_idx_suffix is coded by a fixed-length code or a truncated binary code. The index of the last significant coefficient in scanning order within a transform block LastSignificantCoeffIdx is derived as follows:

```
If last_sig_coeff_idx_suffix is less than 2, the following applies:
  LastSignificantCoeffIdx = last_sig_coeff_idx_prefix
Otherwise (last_sig_coeff_idx_suffix is greater than or equal to 2), the
following applies:
  LastSignificantCoeffIdx = ( 1 << (last_sig_coeff_idx_prefix − 1) )
    + last_sig_coeff_idx_suffix
```

In some embodiments, the video coder signals the information on the position of the last significant coefficient in scanning order within a transform block adaptively. The video coder may choose to entropy encode or decode the position of the last significant coefficient based on the Cartesian coordinates or the scanning order index of the last significant coefficients adaptively determined by explicitly coded syntax information or some pre-defined rules.

In some embodiments, the video coder may determine the selected entropy coding method for signaling the information on the position of the last significant coefficient in scanning order within a transform block based on the transform type that is applied to the current transform block. For example, a video coder may signal information on the position of the last significant coefficient in scanning order within a current transform block by entropy coding the index of the last significant coefficient in scanning order within the current transform block when the transform type on the current transform block belongs to two-dimensional non-separable transform types, including low-frequency non-separable transform (LFNST) and non-separable primary transform (NSPT) that are indicated by a syntax element. For example, in some embodiments, an indication for using non-separable transform (e.g., lfnst_idx, which selects a LFNST type) is signaled before the index of the last significant coefficient in scanning order is signaled. Only when there is indication that non-separable transform is used (e.g., lfnst_idx>0) would the index of the last significant coefficient in scanning order be signaled, otherwise the position of the last significant coefficient would be signaled based on the last coefficient's Cartesian coordinates in the transform block.

In some embodiments, the maximum codeword value for signaling the index of the last significant coefficient of a LFNST or NSPT transform block is determined by the pre-defined maximum number of non-zero transform coefficients according to the block dimension of the current LFNST or NSPT transform block. The video coder may signal information on the position of the last significant coefficient in scanning order within a current transform block by entropy coding the Cartesian coordinates of the last significant coefficients when the transform type on the current transform block belongs to two-dimensional separable transform types. The video coder may further signal syntax information to indicate the transform type associated with the current transform block before signaling syntax information on the position of the last significant coefficient. The video coder may also use separate context sets for entropy coding the position of the last significant coefficient by different methods or different transform types.

The video coder may further signal one or more syntax elements in one or more high-level syntax sets to indicate whether the method of signaling the position of the last significant coefficient described above is enabled or disabled in a current video data unit, wherein the high-level syntax sets may comprise SPS, PPS, PH, SH, or a combination thereof.

Any of the foregoing proposed methods can be implemented in encoders and/or decoders. For example, any of the proposed methods can be implemented in an entropy coding module of an encoder, and/or an entropy coding module of a decoder. Alternatively, any of the proposed methods can be implemented as a circuit integrated to the entropy coding module of the encoder and/or the entropy coding module of the decoder. The proposed aspects, methods and related embodiments can be implemented individually or jointly in an image and video coding system.

### II. Example Video Encoder

FIG. 4 illustrates an example video encoder 400 that entropy encodes transform coefficients. As illustrated, the video encoder 400 receives input video signal from a video source 405 and encodes the signal into bitstream 495. The video encoder 400 has several components or modules for encoding the signal from the video source 405, at least including some components selected from a transform module 410, a quantization module 411, an inverse quantization module 414, an inverse transform module 415, an intra-picture estimation module 420, an intra-prediction module 425, a motion compensation module 430, a motion estimation module 435, an in-loop filter 445, a reconstructed picture buffer 450, a MV buffer 465, and a MV prediction module 475, and an entropy encoder 490. The motion compensation module 430 and the motion estimation module 435 are part of an inter-prediction module 440.

In some embodiments, the modules 410-490 are modules of software instructions being executed by one or more processing units (e.g., a processor) of a computing device or electronic apparatus. In some embodiments, the modules 410-490 are modules of hardware circuits implemented by one or more integrated circuits (ICs) of an electronic apparatus. Though the modules 410-490 are illustrated as being separate modules, some of the modules can be combined into a single module.

The video source 405 provides a raw video signal that presents pixel data of each video frame without compression. A subtractor 408 computes the difference between the raw video pixel data of the video source 405 and the predicted pixel data 413 from the motion compensation module 430 or intra-prediction module 425 as prediction residual 409. The transform module 410 converts the difference (or the residual pixel data or residual signal 408) into transform coefficients (e.g., by performing Discrete Cosine Transform, or DCT). The quantization module 411 quantizes the transform coefficients into quantized data (or quantized coefficients) 412, which is encoded into the bitstream 495 by the entropy encoder 490.

The inverse quantization module 414 de-quantizes the quantized data (or quantized coefficients) 412 to obtain transform coefficients, and the inverse transform module 415 performs inverse transform on the transform coefficients to produce reconstructed residual 419. The reconstructed residual 419 is added with the predicted pixel data 413 to produce reconstructed pixel data 417. In some embodiments, the reconstructed pixel data 417 is temporarily stored in a line buffer (not illustrated) for intra-picture prediction and spatial MV prediction. The reconstructed pixels are filtered by the in-loop filter 445 and stored in the reconstructed picture buffer 450. In some embodiments, the reconstructed picture buffer 450 is a storage external to the video encoder 400. In some embodiments, the reconstructed picture buffer 450 is a storage internal to the video encoder 400.

The intra-picture estimation module 420 performs intra-prediction based on the reconstructed pixel data 417 to produce intra prediction data. The intra-prediction data is provided to the entropy encoder 490 to be encoded into bitstream 495. The intra-prediction data is also used by the intra-prediction module 425 to produce the predicted pixel data 413.

The motion estimation module 435 performs inter-prediction by producing MVs to reference pixel data of previously decoded frames stored in the reconstructed picture buffer 450. These MVs are provided to the motion compensation module 430 to produce predicted pixel data.

Instead of encoding the complete actual MVs in the bitstream, the video encoder 400 uses MV prediction to generate predicted MVs, and the difference between the MVs used for motion compensation and the predicted MVs is encoded as residual motion data and stored in the bitstream 495.

The MV prediction module 475 generates the predicted MVs based on reference MVs that were generated for encoding previously video frames, i.e., the motion compensation MVs that were used to perform motion compensation. The MV prediction module 475 retrieves reference MVs from previous video frames from the MV buffer 465. The video encoder 400 stores the MVs generated for the current video frame in the MV buffer 465 as reference MVs for generating predicted MVs.

The MV prediction module 475 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 495 by the entropy encoder 490.

The entropy encoder 490 encodes various parameters and data into the bitstream 495 by using entropy-coding techniques such as context-adaptive binary arithmetic coding (CABAC) or Huffman encoding. The entropy encoder 490 encodes various header elements, flags, along with the quantized transform coefficients 412, and the residual motion data as syntax elements into the bitstream 495. The bitstream 495 is in turn stored in a storage device or transmitted to a decoder over a communications medium such as a network.

The in-loop filter 445 performs filtering or smoothing operations on the reconstructed pixel data 417 to reduce the artifacts of coding, particularly at boundaries of pixel blocks. In some embodiments, the filtering or smoothing operations performed by the in-loop filter 445 include deblock filter (DBF), sample adaptive offset (SAO), and/or adaptive loop filter (ALF).

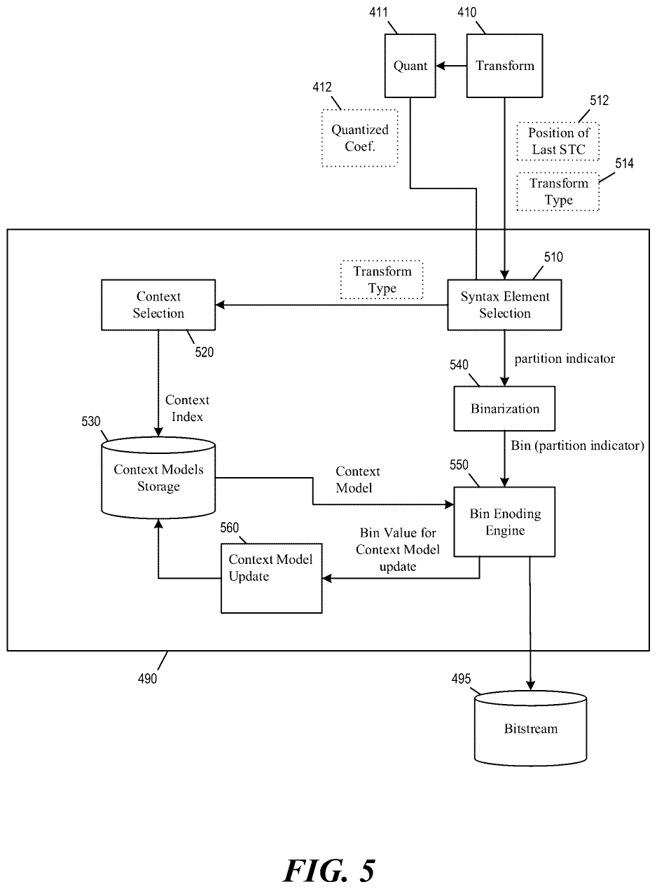

FIG. 5 illustrates portions of the video encoder 400 that signals a position of the last significant transform coefficient. Specifically, the figure illustrates the components of the entropy encoder 490 when entropy encoding a transform block of the current block.

As illustrated, the entropy encoder 490 includes a syntax element selection module 510, a context selection module 520, a context models storage 530, a binarization module 540, a bin encoding engine 550, and a context model update module 560.

The syntax element selection module 510 selects data to be encoded as syntax elements in the bitstream 495 from various sources of the video encoder 400, including quantized coefficients 412, a position of last significant transform coefficient 512, and a transform type 514 for the current transform block from the quantizer 411 and the transform module 410. The syntax element selection module 510 may use the position of the last significant transform coefficient 512 to determine how many or which quantized transform coefficients of the transform block is to be entropy encoded. The syntax element selection module 510 may also use the transform type 514 to adaptively determine how to indicate the position of last significant transform coefficient 512, whether as an index in the scan order (if LFNST or NSPT) or as a Cartesian coordinate in the transform block.

The data selected as syntax element is passed to the binarization module 540, which convert the selected data into bins. The bin encoding engine 550 in turn performs binary arithmetic coding to convert the bins into binary arithmetic codes to be included in the bitstream 495. The binary arithmetic coding operation relies on context modeling, which provides a context model based on probabilities specific to the type of syntax element being coded. The different context models of the different types of syntax elements are stored at the context models storage 530. The context model update module 560 updates the probabilities of the various context models based on the bin values that are processed at the bin encoding engine 550. The context model being used by the bin encoding engine 550 is retrieved from the context models storage 530 based on a context index provided by the context selection module 520. For example, in some embodiments, the context selection module 520 may apply different context sets for entropy encoding the position of the last transform coefficient for different transform types as indicated by the transform type 514.

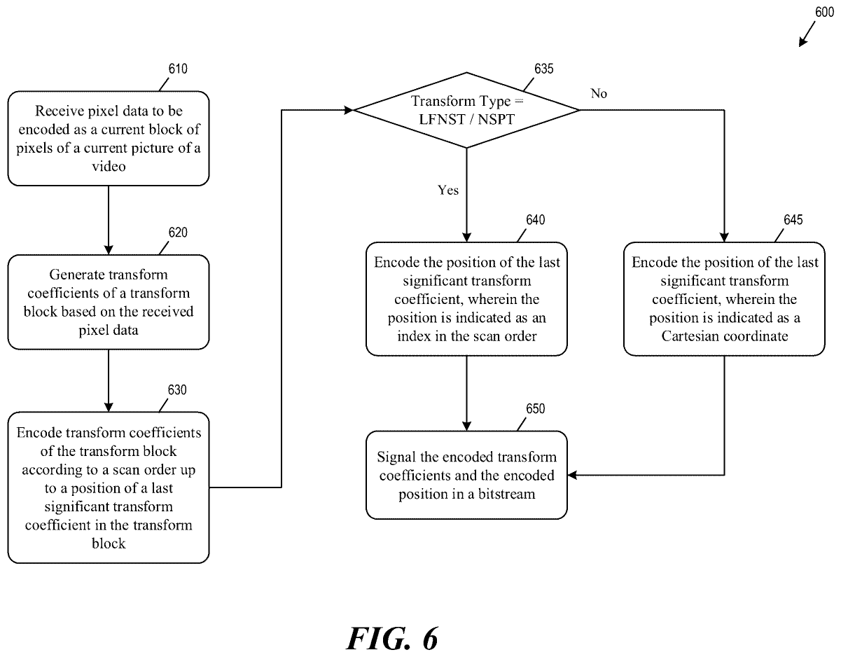

FIG. 6 conceptually illustrates a process 600 for entropy coding transform coefficients. In some embodiments, one or more processing units (e.g., a processor) of a computing device implementing the encoder 400 performs the process 600 by executing instructions stored in a computer readable medium. In some embodiments, an electronic apparatus implementing the encoder 400 performs the process 600.

The encoder receives (at block 610) pixel data to be encoded as a current block of pixels of a current picture of a video.

The encoder generates (at block 620) transform coefficients of a transform block based on the received pixel data. The received pixel data may be converted to prediction residuals using a prediction of the current block, and the transform coefficients may be generated by transforming the prediction residuals.

The encoder encodes (at block 630) (e.g., by quantizing and entropy encoding) one or more transform coefficients of the transform block according to a scan order based on (up to or from) the position of a last significant transform coefficient in the transform block. In some embodiments, less than a total number of transform coefficients of the transform block may be encoded in the received data.

The encoder determines (at block 635) whether the transform type of the transform block belonging to a two-dimensional non-separable transform type (e.g., LFNST, NSPT). In some embodiments, the position of the last significant transform coefficient is indicated adaptively as either an index in the scan order or Cartesian coordinates in the transform block based on a transform type used to generate the transform coefficients of the transform block. In some embodiments, the transform type of the transform block is signaled before the position of the last significant transform coefficient. In some embodiments, the position of the last significant transform coefficient is entropy encoded by separate context sets for different transform types. When the transform type is a two-dimensional non-separable transform type, the process proceeds to block 640. When the transform type is not a two-dimensional non-separable transform type, the process proceeds to blocks 645 to signal the position of the last significant transform coefficient by encoding the Cartesian coordinates of the last significant transform coefficient in the transform block and to signal the encoded transform coefficients in a bitstream.

The encoder encodes (at block 640) (e.g., by entropy encoding) the position of the last significant transform coefficient as an index in the scan order. In some embodiments, the transform coefficients of the transform block are assigned indices corresponding to their respective positions in the scan order. In some embodiments, a maximum codeword value for signaling the index of the position of the last significant transform coefficient is determined by a pre-defined maximum number of transform coefficients for the transform block. In some embodiments, the index of the position of the last significant transform coefficient is signaled as a prefix syntax element and a suffix syntax element (e.g., as syntax elements last_sig-coeff_idx_prefix and last_sig-coeff_idx_suffix.) The encoder then signals (at block 650) the encoded transform coefficients and the encoded position in a bitstream.

### III. Example Video Decoder

In some embodiments, an encoder may signal (or generate) one or more syntax element in a bitstream, such that a decoder may parse said one or more syntax element from the bitstream.

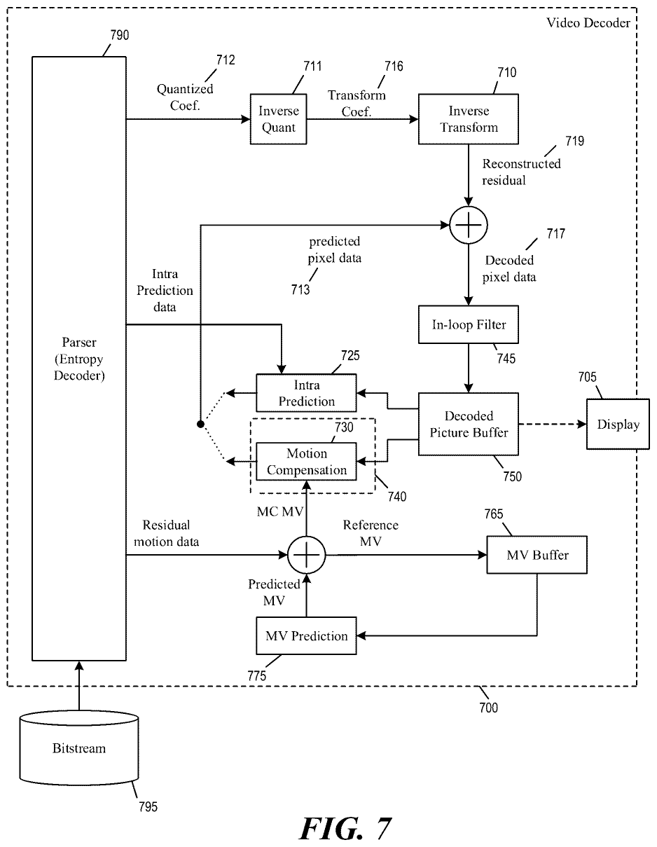

FIG. 7 illustrates an example video decoder 700 that entropy decodes transform coefficients. As illustrated, the video decoder 700 is an image-decoding or video-decoding circuit that receives a bitstream 795 and decodes the content of the bitstream into pixel data of video frames for display. The video decoder 700 has several components or modules for decoding the bitstream 795, including some components selected from an inverse quantization module 711, an inverse transform module 710, an intra-prediction module 725, a motion compensation module 730, an in-loop filter 745, a decoded picture buffer 750, a MV buffer 765, a MV prediction module 775, and a parser 790. The motion compensation module 730 is part of an inter-prediction module 740.

In some embodiments, the modules 710-790 are modules of software instructions being executed by one or more processing units (e.g., a processor) of a computing device. In some embodiments, the modules 710-790 are modules of hardware circuits implemented by one or more ICs of an electronic apparatus. Though the modules 710-790 are illustrated as being separate modules, some of the modules can be combined into a single module.

The parser 790 (or entropy decoder) receives the bitstream 795 and performs initial parsing according to the syntax defined by a video-coding or image-coding standard. The parsed syntax element includes various header elements, flags, as well as quantized data (or quantized coefficients) 712. The parser 790 parses out the various syntax elements by using entropy-coding techniques such as context-adaptive binary arithmetic coding (CABAC) or Huffman encoding.

The inverse quantization module 711 de-quantizes the quantized data (or quantized coefficients) 712 to obtain transform coefficients, and the inverse transform module 710 performs inverse transform on the transform coefficients 716 to produce reconstructed residual signal 719. The reconstructed residual signal 719 is added with predicted pixel data 713 from the intra-prediction module 725 or the motion compensation module 730 to produce decoded pixel data 717. The decoded pixels data are filtered by the in-loop filter 745 and stored in the decoded picture buffer 750. In some embodiments, the decoded picture buffer 750 is a storage external to the video decoder 700. In some embodiments, the decoded picture buffer 750 is a storage internal to the video decoder 700.

The intra-prediction module 725 receives intra-prediction data from bitstream 795 and according to which, produces the predicted pixel data 713 from the decoded pixel data 717 stored in the decoded picture buffer 750. In some embodiments, the decoded pixel data 717 is also stored in a line buffer (not illustrated) for intra-picture prediction and spatial MV prediction.

In some embodiments, the content of the decoded picture buffer 750 is used for display. A display device 705 either retrieves the content of the decoded picture buffer 750 for display directly, or retrieves the content of the decoded picture buffer to a display buffer. In some embodiments, the display device receives pixel values from the decoded picture buffer 750 through a pixel transport.

The motion compensation module 730 produces predicted pixel data 713 from the decoded pixel data 717 stored in the decoded picture buffer 750 according to motion compensation MVs (MC MVs). These motion compensation MVs are decoded by adding the residual motion data received from the bitstream 795 with predicted MVs received from the MV prediction module 775.

The MV prediction module 775 generates the predicted MVs based on reference MVs that were generated for decoding previous video frames, e.g., the motion compensation MVs that were used to perform motion compensation. The MV prediction module 775 retrieves the reference MVs of previous video frames from the MV buffer 765. The video decoder 700 stores the motion compensation MVs generated for decoding the current video frame in the MV buffer 765 as reference MVs for producing predicted MVs.

The in-loop filter 745 performs filtering or smoothing operations on the decoded pixel data 717 to reduce the artifacts of coding, particularly at boundaries of pixel blocks. In some embodiments, the filtering or smoothing operations performed by the in-loop filter 745 include deblock filter (DBF), sample adaptive offset (SAO), and/or adaptive loop filter (ALF).

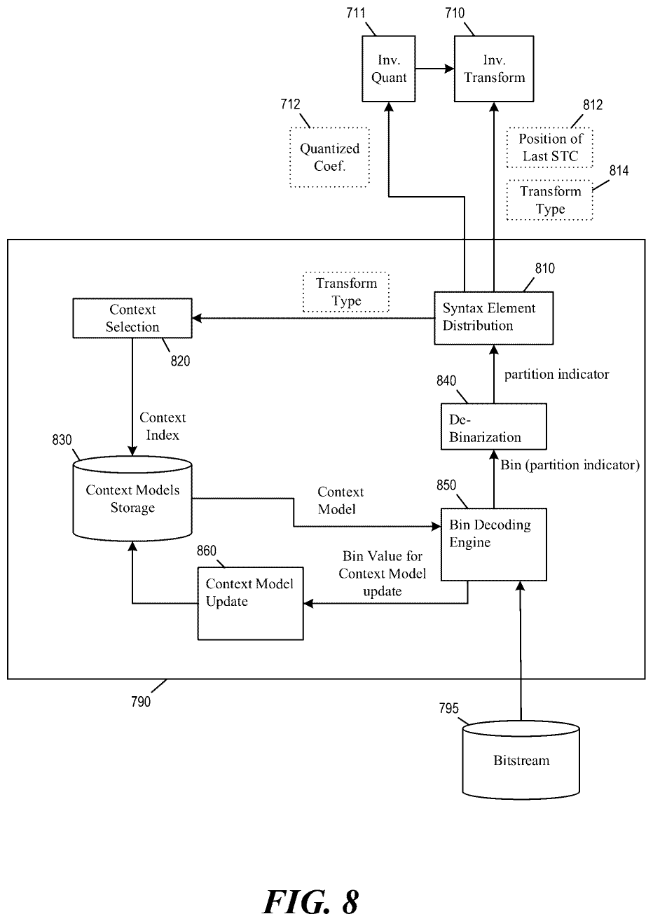

FIG. 8 illustrates portions of the video decoder 700 that receives a position of the last significant transform coefficient. Specifically, the figure illustrates the components of the entropy decoder 790 when entropy decoding a transform block of the current block.

As illustrated, the entropy decoder 790 includes a syntax element distribution module 810, a context selection module 820, a context models storage 830, a de-binarization module 840, a bin decoding engine 850, and a context model update module 860.

The bin decoding engine 850 receives bits from the bitstream 795 and performs binary arithmetic coding to convert the received bits into bins. The binary arithmetic coding operation relies on context modeling, which provides a context model based on probabilities specific to the type of syntax element being coded.

The different context models of the different types of syntax elements are stored at the context models storage 830. The context model update module 860 updates the probabilities of the various context models based on the bin values that are processed at the bin decoding engine 850. The de-binarization module 840 converts the bins into syntax elements. The decoded syntax elements are in turn distributed to various destinations in the video decoder 700 by the syntax element distribution module 810. As illustrated, decoded syntax elements such as quantized coefficients 712, a position of last significant transform coefficient 812, and a transform type 814 are distributed to the de-quantizer 711 and the inverse transform module 710 for the current transform block.

The inverse transform module 710 may use the position of the last significant transform coefficient 812 to determine how many or which quantized transform coefficients of the transform block are provided by entropy decoding. The inverse transform module 710 may also use the transform type 814 to adaptively determine how was the position of the last significant transform coefficient 812 indicated, whether as an index in the scan order (if LFNST or NSPT) or as a Cartesian coordinate in the transform block.

The context model being used by the bin decoding engine 850 is retrieved from the context models storage 830 based on context index provided by the context selection module 820. In some embodiments, the context selection module 820 may apply different context sets for entropy decoding the position of the last transform coefficient for different transform types as indicated by the transform type 814.

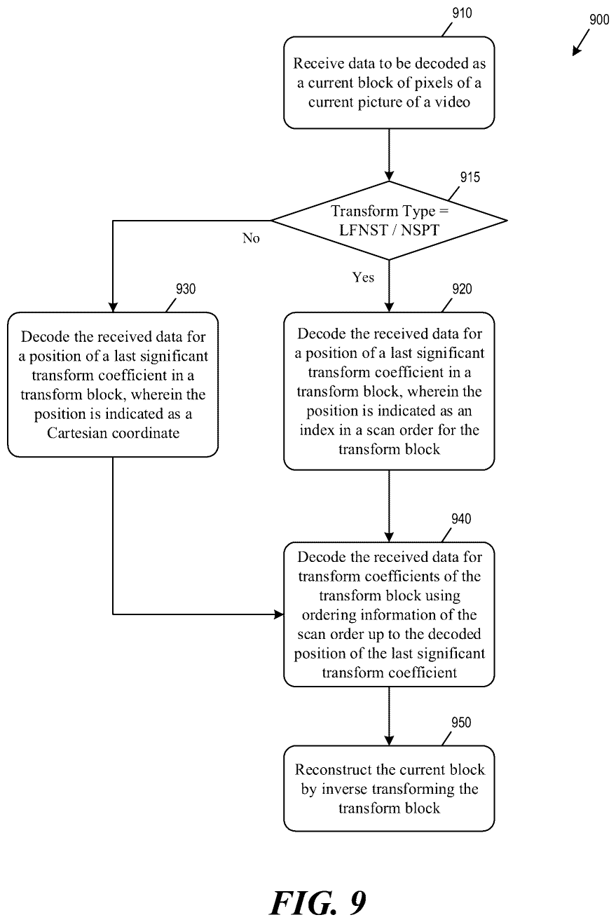

FIG. 9 conceptually illustrates a process 900 that entropy decodes transform coefficients. In some embodiments, one or more processing units (e.g., a processor) of a computing device implementing the decoder 700 performs the process 900 by executing instructions stored in a computer readable medium. In some embodiments, an electronic apparatus implementing the decoder 700 performs the process 900.

The decoder receives (at block 910) data to be decoded as a current block of pixels of a current picture of a video.

The decoder determines (at block 915) whether a transform type of the transform block belonging to a two-dimensional non-separable transform type (e.g., LFNST, NSPT). In some embodiments, the position of the last significant transform coefficient is indicated adaptively as either an index in the scan order or a Cartesian coordinate in the transform block based on the transform type used to generate the transform coefficients of the transform block. In some embodiments, the transform type of the transform block is signaled before the position of the last significant transform coefficient. In some embodiments, the position of the last significant transform coefficient is entropy decoded by separate context sets for different transform types. When the transform type is a two-dimensional non-separable transform type, the process proceeds to block 920. When the transform type is not a two-dimensional non-separable transform type, the process proceeds to blocks 930.

At block 920, the decoder decodes (e.g., by entropy decoding) the received data for a position of the last significant transform coefficient as an index in the scan order. In some embodiments, the transform coefficients of the transform block are assigned indices corresponding to their respective positions in the scan order. In some embodiments, a maximum codeword value for signaling the index of the position of the last significant transform coefficient is determined by a pre-defined maximum number of transform coefficients for the transform block. In some embodiments, the index of the position of the last significant transform coefficient is signaled as a prefix syntax element and a suffix syntax element (e.g., as syntax elements last_sig-coeff_idx_prefix and last_sig-coeff_idx_suffix.)

At block 930, the decoder decodes the received data for a position of the last significant transform coefficient as a Cartesian coordinate in the transform block. The process proceeds to block 950.

The decoder decodes (at block 940) (e.g., by de-quantizing and entropy decoding) one or more transform coefficients of the transform block using ordering information of the scan order based on (from or up to) a position of a last significant transform coefficient in the transform block. In some embodiments, less than a total number of transform coefficients of the transform block may be decoded from the received data.

The decoder reconstructs (at block 950) the current block by inverse transforming the transform block (e.g., into prediction residuals to be combined with a predictor of the current block.) The decoder may then provide the reconstructed current block for display as part of the reconstructed current picture.

### IV. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

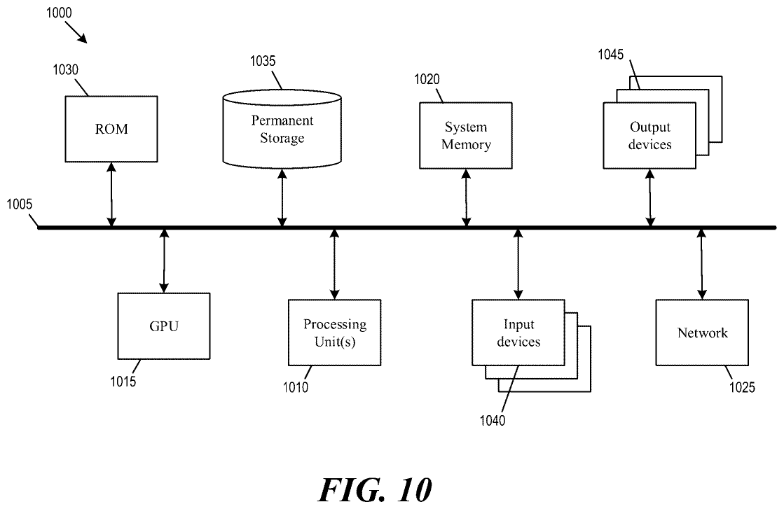

FIG. 10 conceptually illustrates an electronic system 1000 with which some embodiments of the present disclosure are implemented. The electronic system 1000 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1000 includes a bus 1005, processing unit(s) 1010, a graphics-processing unit (GPU) 1015, a system memory 1020, a network 1025, a read-only memory 1030, a permanent storage device 1035, input devices 1040, and output devices 1045.

The bus 1005 collectively represents all system, peripheral, and chipset buses that communicatively connect the numerous internal devices of the electronic system 1000. For instance, the bus 1005 communicatively connects the processing unit(s) 1010 with the GPU 1015, the read-only memory 1030, the system memory 1020, and the permanent storage device 1035.

From these various memory units, the processing unit(s) 1010 retrieves instructions to execute and data to process in order to execute the processes of the present disclosure. The processing unit(s) may be a single processor or a multi-core processor in different embodiments. Some instructions are passed to and executed by the GPU 1015. The GPU 1015 can offload various computations or complement the image processing provided by the processing unit(s) 1010.

The read-only-memory (ROM) 1030 stores static data and instructions that are used by the processing unit(s) 1010 and other modules of the electronic system. The permanent storage device 1035, on the other hand, is a read-and-write memory device. This device is a non-volatile memory unit that stores instructions and data even when the electronic system 1000 is off. Some embodiments of the present disclosure use a mass-storage device (such as a magnetic or optical disk and its corresponding disk drive) as the permanent storage device 1035.

Other embodiments use a removable storage device (such as a floppy disk, flash memory device, etc., and its corresponding disk drive) as the permanent storage device. Like the permanent storage device 1035, the system memory 1020 is a read-and-write memory device. However, unlike storage device 1035, the system memory 1020 is a volatile read-and-write memory, such a random access memory. The system memory 1020 stores some of the instructions and data that the processor uses at runtime. In some embodiments, processes in accordance with the present disclosure are stored in the system memory 1020, the permanent storage device 1035, and/or the read-only memory 1030. For example, the various memory units include instructions for processing multimedia clips in accordance with some embodiments. From these various memory units, the processing unit(s) 1010 retrieves instructions to execute and data to process in order to execute the processes of some embodiments.

The bus 1005 also connects to the input and output devices 1040 and 1045. The input devices 1040 enable the user to communicate information and select commands to the electronic system. The input devices 1040 include alphanumeric keyboards and pointing devices (also called “cursor control devices”), cameras (e.g., webcams), microphones or similar devices for receiving voice commands, etc. The output devices 1045 display images generated by the electronic system or otherwise output data. The output devices 1045 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 10, bus 1005 also couples electronic system 1000 to a network 1025 through a network adapter (not shown). In this manner, the computer can be a part of a network of computers (such as a local area network (“LAN”), a wide area network (“WAN”), or an Intranet, or a network of networks, such as the Internet. Any or all components of electronic system 1000 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable

Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 6 and FIG. 9) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method for encoding or decoding a current block of pixels of a video, the method comprising:
receiving input data associated with the current block, wherein the input data correspond to quantized transform coefficients associated with the current block to be encoded at an encoder side or the input data correspond to coded quantized transform coefficients associated with the current block to be decoded at a decoder side;
encoding or decoding a position of a last significant transform coefficient according to a predefined scan order for a transform block, wherein encoding or decoding the position of the last significant transform coefficient comprises encoding or decoding an index of the last significant transform coefficient according to the predefined scan order; and
encoding or decoding transform coefficients of the transform block using ordering information of the predefined scan order based on the position of the last significant transform coefficient.

2. The video coding method of claim 1, wherein the transform coefficients are generated by a transform belonging to a two-dimensional non-separable transform type.

3. The video coding method of claim 1, wherein a syntax element indicating whether a transform type of the transform block is a two-dimensional non-separable transform type is signaled before the position of the last significant transform coefficient.

4. The video coding method of claim 3, wherein the syntax element indicates a selected low-frequency non-separable transform (LFNST) or non-separable primary transform (NSPT) transform index or indicates whether the transform type of the transform block is a LFNST or NSPT transform type.

5. The video coding method of claim 3, wherein encoding or decoding the position of the last significant transform coefficient comprises encoding or decoding cartesian coordinates of the last significant transform coefficient in the transform block when the transform type does not indicate a two-dimensional non-separable transform type.

6. The video coding method of claim 1, wherein the position of the last significant transform coefficient is signaled adaptively by encoding or decoding an index in the predefined scan order or Cartesian coordinates of the last significant transform coefficient in the transform block based on a transform type used to generate the transform coefficients of the transform block.

7. The video coding method of claim 6, wherein encoding or decoding the position of the last significant transform coefficient comprises applying separate context sets for different transform types.

8. The video coding method of claim 1, wherein a maximum codeword value for signaling the index of the position of the last significant transform coefficient is determined by a pre-defined maximum number of transform coefficients for the transform block.

9. The video coding method of claim 1, wherein less than a total number of transform coefficients in the transform block are entropy encoded or entropy decoded.

10. The video coding method of claim 1, wherein the index of the position of the last significant transform coefficient is signaled as a prefix syntax element and a suffix syntax element.

11. An electronic apparatus comprising:
a video coder circuit configured to perform operations comprising:
receiving input data associated with the current block, wherein the input data correspond to quantized transform coefficients associated with the current block to be entropy encoded at an encoder side or the input data correspond to coded quantized transform coefficients associated with the current block to be decoded at a decoder side, wherein the transform coefficients are generated by a transform belonging to a two-dimensional non-separable transform type;
encoding or decoding a position of a last significant transform coefficient according to a predefined scan order for a transform block, wherein encoding or decoding the position of the last significant transform coefficient comprises encoding or decoding an index of the last significant transform coefficient according to the predefined scan order; and
encoding or decoding transform coefficients of the transform block using ordering information of the predefined scan order based on the position of the last significant transform coefficient.

12. A video encoding method comprising:
receiving pixel data to be encoded as a current block of pixels of a current picture of a video;
generating transform coefficients of a transform block based on the received pixel data;
encoding transform coefficients of the transform block according to a scan order based on a position of a last significant transform coefficient in the transform block;
encoding the position of the last significant transform coefficient, wherein the position is indicated as an index in the scan order; and
signaling the encoded transform coefficients and the encoded position in a bitstream.

13. A video decoding method comprising:
receiving data to be decoded as a current block of pixels of a current picture of a video;
decoding the received data for a position of a last significant transform coefficient in a transform block, wherein the position is indicated as an index in a scan order for the transform block;
decoding the received data for transform coefficients of the transform block according to the scan order based on the decoded position of the last significant transform coefficient when a transform type of the transform block indicates low-frequency non-separable transform (LFNST) or non-separable primary transform (NSPT) transform; and
reconstructing the current block by inverse transforming the transform block.
